(19) United States
(12) Patent Application Publication
(10) Pub. No.: US 2005/0044800 A1
(43) Pub. Date: Mar. 3, 2005

(54) Container assembly for HPHT processing

(76) Inventors: David R. Hall, Provo, UT (US); Joe Fox, Provo, CT (US)

Correspondence Address: David R. Hall, 2185 S Larsen Pkwy, Provo, UT, 84606, US

(21) Appl. No.: 10/654,512

(22) Filed: Sep. 3, 2003

(51) Int. Cl. C09C 1/68

(52) U.S. Cl. 51/307

(57) ABSTRACT

An assembly for High-Pressure High-Temperature (HPHT) processing comprising a can, a cap, a meltable sealant and sealant barrier, and a superhard mixture comprising superhard particles. The superhard particles may be positioned adjacent a substrate of cemented metal carbide. The can and cap contain the superhard mixture with the sealant barrier positioned within the assembly so as to be intermediate the sealant and at least a portion of the mixture, thereby preventing the sealant from coming in contact with the mixture during processing. The assembly is placed within a vacuum chamber and heated to a temperature sufficient to cleanse the assembly and then melt the sealant providing a hermetic seal for the assembly in preparation for further HPHT processing.

### BACKGROUND OF THE INVENTION

This invention relates to superhard products such as diamond, polycrystalline diamond, and cubic boron nitride produced by the high pressure and high temperature (HPHT) method. More particularly this invention relates to the HPHT container or can assembly in which the superhard materials are processed. The assembly comprises a metal can containing the superhard materials, an end cap, a meltable sealant, and a sealant barrier, the improvement being the use of the sealant barrier to prevent contamination of the superhard materials during processing.

Superhard materials by the HPHT method are produced by encapsulating the materials into a container, variously known in the art as a container, a can, an enclosure, a cup, a shield, and a tube. The applicants prefer the term “can”, and, therefore, all references to a “can” in this application refer to the container as used in the art.

Examples of some of the methods for producing superhard materials are reported in U.S. Pat. No. 4,954,139, to Cerutti, and U.S. Pat. No. 4,518,659, to Gigl et al., both of which are incorporated herein by this reference for all that they teach and claim.

Producing superhard materials is somewhat problematic due to the nature of the materials used and of the extreme conditions under which they must be processed. Generally, the raw materials for the production of superhard products are in the form of ceramic and hard metal composites and fine powders. These materials must be cleaned of foreign particles and oxides in preparation for HPHT processing. This may be accomplished by either subjecting the components to high heat, a reducing environment, or to high vacuum, or a combination thereof. Afterwards, the HPHT components must be protected before and during processing from unwanted impurities and contamination by sealing the components in a metal can. The sealed can, then, must be suitable for processing under conditions of elevated pressure and temperature as reported in the art. The can components are usually refractory materials comprising the can and a lid. It is also known to employ a sleeve, disks, and/or a cap, over the lid as additional levels of protection. The can components are either tightly fit together, or are pressed together in assembly to make a tight seal. It may be desirable to seal the can further using a braze procedure, a vacuum braze procedure, or electron-beam welding, which may also be accomplished in a vacuum.

Examples of the vacuum braze sealing techniques are reported in U.S. Pat. No. 4,333,902, to Hara, and U.S. Pat. No. 4,425,315, to Tsuji et al., both disclosures are incorporated herein by this reference for all that they teach and claim.

The Hara reference discloses a process for producing a sintered compact by filling a cup with a powdered material mixture and putting on the opening of the cup a covering consisting of a lid and solder so as to permit ventilation between the interior and exterior of the cup assembly. The cup assembly is then placed inside a chamber in a vacuum furnace and taken to a high vacuum. While at the desired level of vacuum, the cup is heated to a sufficient temperature to cleanse the can elements and HPHT materials. Then, the temperature in the chamber is increased to melt the solder. By capillary action the solder melts around the cup and the lid and hermitically seals the container. Afterwards, the oven is cooled and the vacuum released and the sealed container retrieved for further HPHT processing.

When solder compositions are detrimental to the sintering process, a means must be provided to protect the HPHT materials mixture from contamination during the sealing process. The methods disclosed in Hara position the solder either adjacent the HPHT materials, or provide a capillary path between the HPHT materials and the solder, without providing a means of protecting the HPHT materials mixture from contamination from the solder. As a result, the flow of the solder by capillary action tends to contaminate the sintered materials producing low quality products and low production yields.

The Tsuji reference, and its related references, all incorporated herein by this reference, disclose a method of producing HPHT sintered bodies using a process similar to that disclosed in the Hara reference and further teaching the use of a container assembly comprising inner and outer refractory sleeves, in addition to the ventilating solder material and lid. Although the inner and outer sleeves are referred to in the disclosure as providing a double seal, a narrow opening is provided between the overlapping sleeves. The opening is necessary for a ventilation path from the HPHT materials mixture to the vacuum chamber. Also, the opening provides the surface energy to drive the capillary flow of the sealant. Once again, no provision is made to protect the HPHT materials mixture from contamination from the solder.

U.S. Pat. No. 6,596,225, to Pope et al., and its related references, all incorporated herein by this reference, teach sealing of the can by electron beam welding at high temperature and in a vacuum. However, no details are disclosed concerning the method.

Therefore, it is desirable in the art of HPHT processing of superhard materials that the can assembly provides for a hermetic seal that protects the assembly from contamination and for protecting the HPHT materials mixture from contamination during the sealing process as well as during HPHT processing by the use of a solder/sealant barrier.

### SUMMARY OF THE INVENTION

This invention presents a refractory can assembly for High-Pressure High-Temperature (HPHI) processing of superhard materials mixtures such as diamond and cubic boron nitride. The can is used to contain the superhard materials during processing. The assembly's components comprise a can, a cap, a meltable sealant, a sealant barrier, and a superhard mixture comprising superhard particles. The components of the can assembly are arranged so as to allow for the ventilation of the contaminants from the HPHT materials mixture and simultaneously provide an extended path between the meltable sealant and the HPHT materials mixture. The meltable sealant may be a solder or braze material. The assembly may also include a lid and disks for further containment. The mixture may include a cemented metal carbide substrate positioned adjacent the superhard particles. The can and cap contain the superhard mixture with the sealant barrier positioned within the assembly so as to be intermediate the sealant and at least a portion of the mixture. The sealant barrier keeps the meltable solder or braze sealant from contaminating the superhard mixture. The assembly is placed within a vacuum chamber and heated to a temperature sufficient to cleanse the assembly and then melt the sealant, thus providing a hermetically sealed assembly in preparation for further HPHT processing. The sealant barrier comprises materials that interrupt the capillary flow of the meltable sealant and may be selected from the group consisting of a stop-off compound, a solder/braze stop, a mask, or a sealant flow control, or a combination thereof.

### BRIEF DESCRIPTION OF THE DRAWINGS

FIG. 1 is a cross-section diagram of a prior art can assembly of the Hara reference.

FIG. 2 is a cross-section diagram of a prior art can assembly of the Tsuji reference.

FIG. 3 is a perspective diagram of a cylindrical embodiment of the present invention.

FIG. 4 is a perspective diagram of a conical embodiment of the present invention.

FIG. 5 is a cross-section diagram of an embodiment of the present invention depicting, inter alia, the meltable sealant and sealant barrier.

FIG. 6 is a cross-section diagram of the embodiment of FIG. 5 depicting, inter alia, the melted sealant and the barrier.

FIG. 7 is a cross-section diagram of an embodiment of the present invention depicting, inter alia, the assembly of FIG. 5 with the addition of the lid or disk as additional protection for the superhard mixture.

FIG. 8 is a cross-section diagram of an embodiment of the present invention depicting, inter alia, the meltable sealant and more than one sealant barrier.

FIG. 9 is a cross-section diagram of an embodiment of the present invention depicting, inter alia, a can assembly having sealant and sealant barrier sleeves.

FIG. 10 is a cross-section diagram of an embodiment of the present invention depicting, inter alia, mechanical crimps in cooperation with the sealant barrier circumscribing the can assembly and HPHT materials mixture.

### DETAILED DESCRIPTION OF THE INVENTION

The present invention will be further described in reference to the following drawing figure diagrams which teach all that is depicted therein and anticipations thereof. Although, the diagrams are representative embodiments of the present invention, it will be obvious to those skilled in the art that deviations from the figures are also beneficial, and such deviations are also within the scope and spirit of the present invention.

FIG. 1 is a cross-section diagram of a prior art can assembly. Can assemblies are generally cylinders closed on one end and open on the other. The can assembly 13 is such a cylinder. Inside the can assembly 13 is the superhard materials mixture 14, comprising a composite of superhard particles for sintering. The can assembly is closed by lid 15, having a sealant material 16 arranged between the lid 15 and superhard material mixture 14. Openings 17 and 18 are provided between the superhard mixture and the can assembly to promote ventilation of contaminants and capillary flow of the meltable sealant 16, in this case copper. The HPHT assembly is heated in a vacuum furnace that produces an environment which cleanses the components of unwanted contaminants and hermetically seals the container in preparation for further HPHT processing.

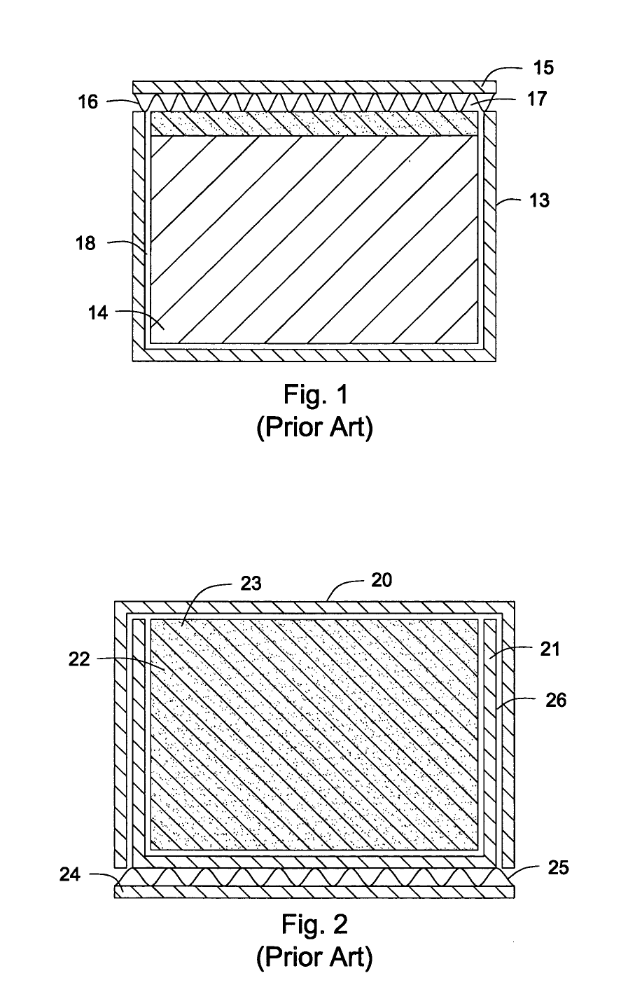

FIG. 2 is a cross-section diagram of a prior art can assembly employing an outer can 20 and an inner can 21. The double can assembly contains the superhard materials mixture comprising a substrate 22 and a layer of superhard particles 23. The assembly is closed by a lid 24 having a meltable sealant 25. Once again an opening 26 is provided between the inner and outer can assembly and the superhard materials mixture in order to allow the flow of contaminants from the can assembly and to promote the capillary flow of the sealant, in this case a copper braze, around the mixture 22 and 23. Although the purpose of the inner and outer can assembly is to provide a better seal from contamination, the figure fails to provide a sealant barrier in the opening 26 to prevent the sealant's access to the mixture. Contamination from undesirable impurities is the leading cause of low quality products and low production yields in the art of HPHT superhard products such as polycrystalline diamond and cubic boron nitride.

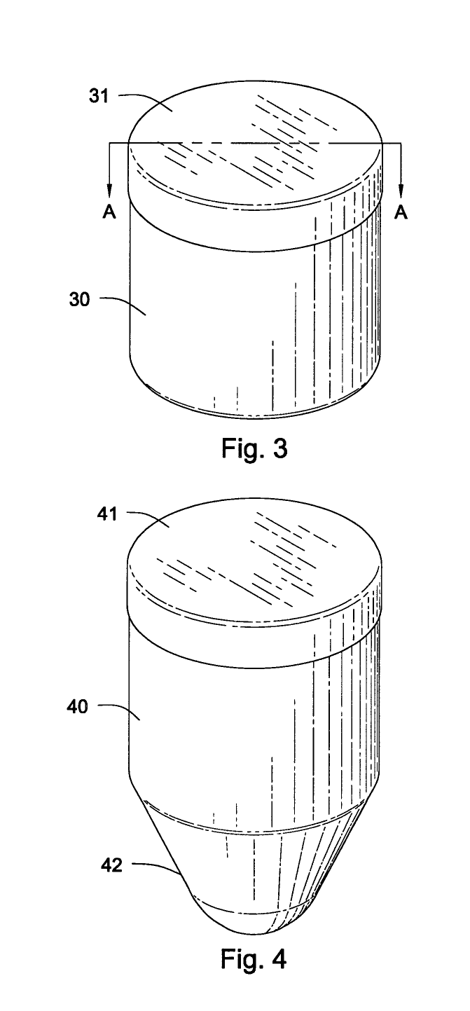

FIG. 3 is a perspective diagram of an embodiment of the can assembly of the present invention comprising a cylindrical can 30 and a cap 31. Line AA describes the plane of the cross section in subsequent figures.

FIG. 4 is a perspective diagram of an embodiment of the can assembly of the present invention comprising a cylindrical can 40 having a convex, or conical, region 42 and an end cap 41. Those skilled in the art will understand that the conical region produces a superhard element having a similar shape.

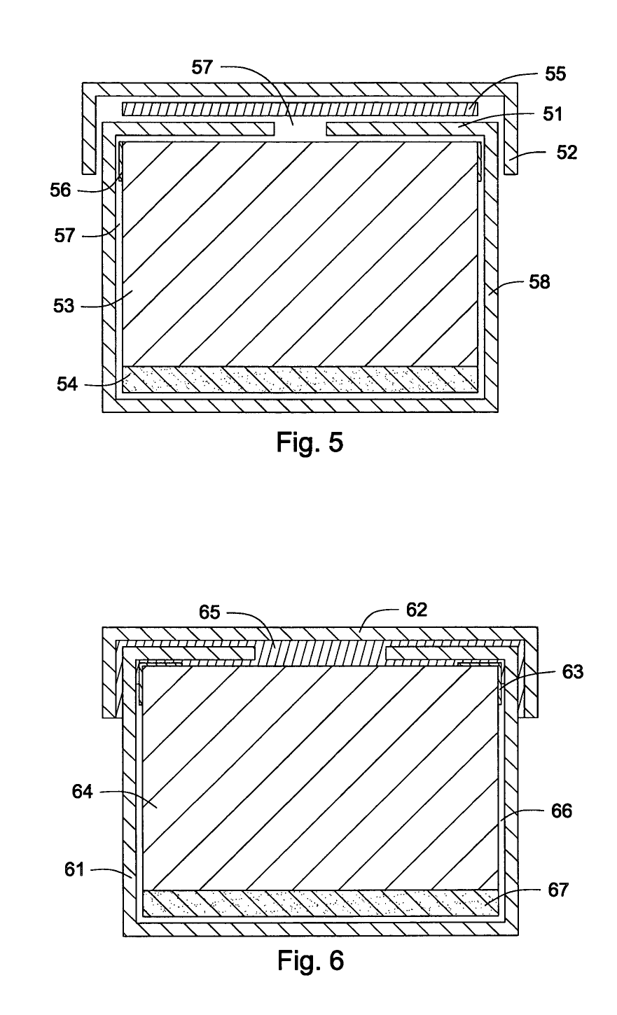

FIG. 5 is a cross-section diagram of an embodiment of the present invention depicting a can assembly comprising a can 50 having an extended side wall length 51. The can contains a superhard substrate 53 and a layer 54 comprising superhard particles such as diamond or cubic boron nitride. The extended side wall length 51 of the can 50 is formed over the surface of substrate 51 in aid of assembly and compaction of the superhard mixture and to promote sealing of the mixture. The can assembly is closed by end cap 52 which is fitted onto the can. A meltable sealant material 55 is interposed between the end cap and the can with access to narrow opening 57. Opening 57 is of sufficient width, say between about 0.0005 to 0.050 inches, to promote the outflow of contamination and yet produce the surface energy necessary to drive the capillary flow of the meltable sealant 55. A sealant barrier 56 is provided around the circumference of the substrate 53 intermediate the meltable sealant 35 and the superhard mixture comprising 53 and 54. When the can assembly of FIG. 5 is placed in the vacuum chamber of a high temperature furnace and placed under high vacuum and high temperature sufficient to ventilate contaminates from the assembly, the assembly is cleansed of undesirable contamination. The temperature of the furnace is then increased sufficiently to melt the sealant. By capillary action, the sealant flows into the opening 57 and hermetically seals the can assembly. The flow of the sealant is stopped by the sealant barrier 56, thereby protecting the cleansed HPHT mixture from further contamination from the sealant itself. The can is then retrieved from the furnace in preparation for further HPHT processing.

The sealant barrier 56 comprises a material that inhibits the surface tension between mating surfaces and interrupts the flow of the sealant melt under the cleansing environment of the vacuum furnace and under the further conditions of HPHT processing. Such materials are commonly known as: Stop-Off, Stop-Off Compound, Solder/Braze Stop, Solder Mask, and Sealant Flow Control. One such material is marketed under the name of “Green Stop-Off Type 1” by Nicrobraz, Wall Colmondy Corporation, Madison Hts., MI. Such sealant barriers comprise refractory materials of inert oxides, graphite, silica, magnesia, yttria, boron nitride, or alumina and are applied by coating, etching, brushing, dipping, spraying, silk screen painting, plating, baking, and chemical or physical vapor deposition techniques. In the embodiment of FIG. 5, the sealant barrier was applied as a paint using a brush. It may be applied to the surface of anyone of the assembly components where it would be desirable to prevent the flow of the liquid sealant.

FIG. 6 is a cross-section diagram of an embodiment of the present invention similar to that depicted in FIG. 5 comprising at can 61 containing a substrate 64 and a superhard mixture 67. The can is closed by end cap 62. The sealant 65 is depicted as melted filling the opening 66 and stopped by the sealant barrier 63 so that it does not flow into the region of the superhard mixture 64 and 67.

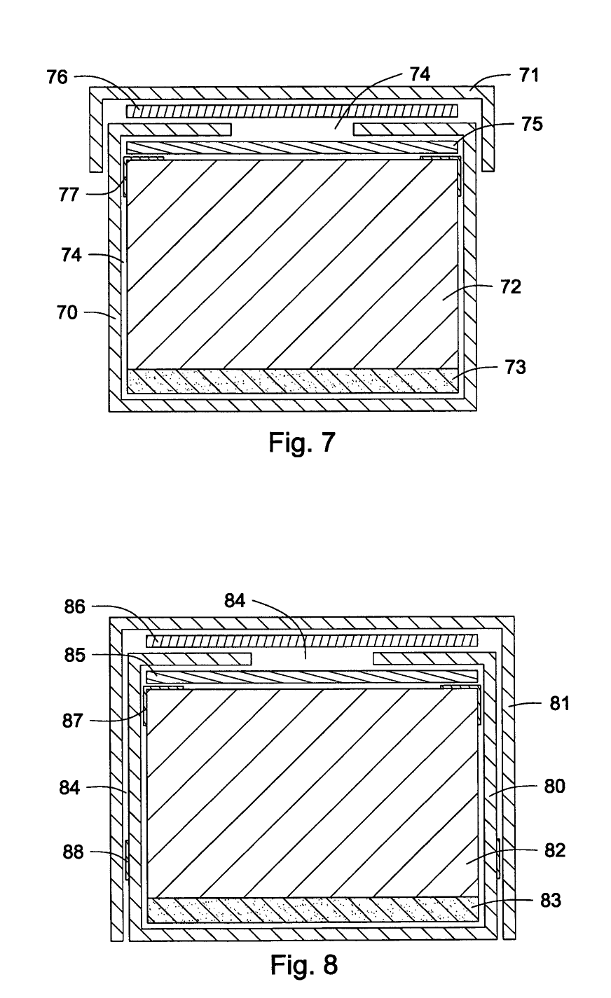

FIG. 7 is a cross-section diagram of an embodiment of the present invention similar to that depicted in FIG. 5 comprising a can 70 and an end cap 71 containing a substrate 72 and superhard particles 73. The assembly comprises the addition of a lid 75 as a further protection for the superhard mixture comprising a substrate 72 and superhard particles 73. The sealant 76 and the sealant barrier 77 are contained within the opening 74 so that when the sealant is melted it flows within the opening 74 around the lid 75 and is stopped by the sealant barrier 77. The can assembly will thereby be hermetically sealed from contamination during further HPHT processing.

FIG. 8 is a cross-section diagram of a double can assembly embodiment of the present invention. The assembly comprises an inner can 80 and an outer can 81 containing a substrate 82 and a mixture of superhard particles 83. Within the space 84 are positioned the lid 85, the sealant 86, and the sealant barrier 87. The assembly also comprises an additional sealant barrier 88. The additional sealant barrier 88 serves to prevent the sealant from escaping the assembly during processing. When the sealant is melted, it flows within the opening 84 to surround the open portion of the can and is confined between the two regions of sealant barrier 87 and 88.

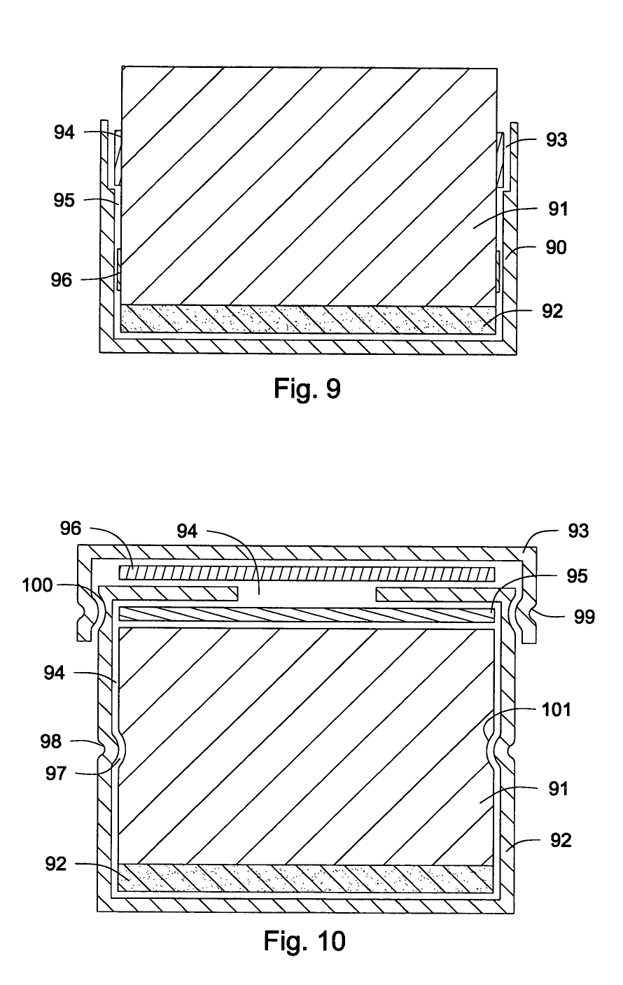

FIG. 9 is a cross-section diagram of a sealable assembly comprising a can 90 containing a substrate 91 and superhard particles 92. The assembly further comprises an opening 95 for positioning a sealant sleeve 94 and a sealant barrier 96, which may be a sleeve or a coating. The can 90 further comprises a recess 93 for cooperating with the insertion of the sealant sleeve 94. The assembly may be swaged together so that the components of the assembly are tightly fit together prior to sealing in a vacuum furnace. As noted in the other figures, the sealant barrier is positioned intermediate the sealant and the superhard particles. In this manner, the superhard particles are protected from undesirable contamination during HPHT processing.

FIG. 10 is a cross-section diagram of a sealed embodiment of the present invention comprising a can 90 and an end cap 93 containing a substrate 91 and superhard particles 92. Within the space 94 are located the lid 95, the sealant 96, and the sealant barrier 97 and 100. In cooperation with the sealant, the assembly comprises a circumferential groove 101 around the substrate 91 and a cooperating indentation 98 in the wall of the can 90. The end cap 93 also comprises cooperating indentations 99 and 100 that may be used in connection with the sealant barrier. When the can assembly is assembled, it may be swaged together so that the components are in tight fit with each other. The cooperating indentations, when used in association with the sealant barrier, provide a mechanical and a chemical stop for the flow for the sealant. Surprisingly, the applicants have found that regardless of the fit between the components, the heat and vacuum of the furnace are sufficient to drive off contaminants within the assembly. It is believed that the during high temperature processing the superhard mixture expands less than the metal can components thereby providing sufficient opening for the escape of contaminants during the vacuum cycle. By maintaining a tight fit between the components, the applicants believe that higher surface tension is achieved to drive the capillary action of the melting sealant. The applicants have found, also, that smooth surface finishes between the can and the superhard components is beneficial for achieving a competent seal.

1. An assembly suitable for HPHT processing, comprising:
a can, a cap, and a mixture;
the assembly further comprising a meltable sealant and a sealant barrier; and
the can containing the mixture wherein the can is assembled with the cap, the sealant, and the sealant barrier such that the sealant barrier is positioned intermediate the sealant and at least a portion of the mixture.

2. The assembly of claim 1, wherein the mixture comprises a composite body comprising a substrate lying adjacent a plurality of superhard particles.

3. The assembly of claim 2, wherein the assembly is heated in a vacuum sufficient to at least partially cleanse the assembly, melt the sealant, bond the cap to the can, and vacuum seal the assembly.

4. The assembly of claim 3, further comprising a lid intermediate the sealant and the mixture, wherein the lid is bonded to the can by the sealant and the assembly is vacuum sealed.

5. The assembly of claim 1, wherein the sealant barrier is adjacent the end cap, the lid, the can, or the mixture, or a combination thereof.

6. The assembly of claim 1, wherein the sealant barrier is applied to the end cap, the lid, or the can, or a combination thereof, prior to assembly.

7. The assembly of claim 1, wherein the sealant barrier comprises a material selected from the group consisting of a stop off compound, a solder/braze stop, a mask, and sealant flow control, or a combination thereof.

8. The assembly of claim 1, wherein the sealant barrier is sufficient to block the flow of at least partially molten sealant under conditions sufficient to cleanse the assembly.

9. The assembly of claim 1, wherein the sealant barrier is sufficient to block the flow of molten sealant under conditions HPHT processing.

10. The assembly of claim 1, wherein the sealant barrier comprises a recess, a groove, or a trough formed in the can, the cap, or the substrate.

11. The assembly of claim 1, wherein the sealant barrier comprises a sleeve.

12. The assembly of claim 1, wherein the sealant barrier comprises a material selected from the group consisting of a paint, a coating, a mask, or a plating.

13. The assembly of claim 1, wherein the sealant begins to flow at a temperature about at least equal to or higher than the temperature required to at least partially cleanse the assembly.

14. The assembly of claim 1, wherein the sealant at least partially melts at a temperature about equal to or greater than the temperature required to at least partially cleanse the assembly.

15. The assembly of claim 1, wherein the sealant comprises a metal, a metal alloy, a metallic compound, or a metallic compound comprising non-metallic elements, having a melting point, or a melting range, at least partially higher than the temperature required to least partially cleanse the assembly.

16. The assembly of claim 1, wherein the sealant is bonded to the end cap, the lid, or the can, or a combination thereof, prior to assembly.

17. The assembly of claim 1, wherein the sealant comprises copper, a copper alloy, or a copper compound having a melting point, or melting range, at least partially higher than the temperature required to cleanse the assembly.

18. The assembly of claim 1, wherein the substrate comprising materials selected from the group consisting of cemented carbides.

19. The assembly of claim 1, wherein the mixture comprises superhard materials selected from the group consisting of diamond, polycrystalline diamond, thermally stable products, polycrystalline diamond depleted of its catalyst, polycrystalline diamond having nonmetallic catalyst, cubic boron nitride, cubic boron nitride depleted of its catalyst, and combinations thereof.

20. An assembly suitable for HPHT processing, comprising:
a can, a cap, a lid, and a mixture for HPHT processing comprising a substrate lying adjacent superhard particles;
the assembly further comprising a meltable sealant and a sealant barrier; and
the can, the cap, and the lid containing the mixture for HPHT processing;
the assembly being cleansed under vacuum and high temperature and thereafter being sealed by the meltable sealant, and the sealant barrier preventing a flow of sealant from contacting the superhard particles.

21. An assembly suitable for HPHT processing, comprising:
a can, a cap, a lid, and a mixture for HPHT processing comprising superhard particles;
the assembly further comprising a meltable sealant and a sealant barrier; and
the can, the cap, and the lid containing the mixture for HPHT processing;
the assembly being cleansed under vacuum and high temperature and thereafter being sealed by the meltable sealant, and the sealant barrier preventing a flow of sealant from contacting the superhard particles.
